(19) United States
(12) Patent Application Publication
(10) Pub. No.: US 2013/0316060 A1
(43) Pub. Date: Nov. 28, 2013

(54) TASTE MODIFIERS

(71) Applicant: DR Pepper/Seven Up, Inc., (US)

(72) Inventors: Stacey K. Walton, Frisco, TX (US); Thais DeNardo, Plano, TX (US); Paul R. Zanno, McKinney, TX (US); Mira Topalovic, Plano, TX (US)

(73) Assignee: DR PEPPER/SEVEN UP, INC., Plano, TX (US)

(21) Appl. No.: 13/678,294

(22) Filed: Nov. 15, 2012

Related U.S. Application Data
(60) Provisional application No. 61/560,154, filed on Nov. 15, 2011.

(51) Int. Cl. A23L 1/22; A23L 2/56

(52) U.S. Cl. CPC A23L 1/22083; A23L 2/56
USPC 426/538

(57) ABSTRACT

A beverage or other composition may include phloretin and trilobtain wherein the weight ratio of phloretin to trilobtain is from about 1:1 to about 3:1. The concentration of phloretin in such a composition may be about 5 ppm to about 150 ppm. The combination of phloretin and trilobtain may remove one or more negative characteristics of the composition.

### CROSS REFERENCE TO RELATED APPLICATIONS

This application claims priority to U.S. Provisional Application Ser. No. 61/560,154 filed Nov. 15, 2011. The disclosure of the aforementioned application is incorporated herein by reference.

### FIELD

The present application relates to taste modifiers, which, for example, can be used in foods, beverages, and pharmaceutical applications, and the use of taste modifiers to alleviate negative flavor attributes.

### BACKGROUND

Diet or reduced-calorie versions of products that are typically sweet may have reduced sugar content, and therefore a lowered contribution of sweetness afforded from caloric sugars. To raise the sweetness level and compensate for the lack of sugar, reduced-calorie products may substitute another sweetening component, e.g., such products may contain high-intensity sweeteners, non-nutritive sweeteners, or combinations thereof. Unfortunately, according to many consumers, such sweeteners, individually or in combination, do not impart exactly the same taste as natural sugars, and such consumers may experience negative taste characteristics of consumable items that include those sweeteners. Negative attributes associated with such consumable items include but are not limited to a lack of upfront sweetness, lingering sweetness, and a lack of overall flavor. Additionally, the general mouthfeel of reduced-calorie consumable items may suffer in the absence of the syrup-like feel or texture that is associated with sugars.

Some of the negative attributes associated with non-sugar sweeteners are related to the temporal profile for initiation of sweetness; that is, following consumption, the time course for delivery of the perception of sweetness. Generally, natural sugars, such as sucrose, which provide sweetness rapidly following consumption and with an appealing rounded profile, are considered to possess an ideal temporal profile. Non-sugar sweeteners may not perfectly match the same time course for sweetness delivery. Moreover, non-sugar sweeteners may, in addition to not providing sweetness with the same temporal pattern as natural sugars, also initiate the perception of other tastes. For example, many consumers describe artificial sweeteners as being associated with taste perceptions, such as metallic, bitter, dry, astringent, other taste perceptions, or combinations thereof. Such perceptions may be particularly strong in periods following consumption, that is, artificial sweeteners may be associated with aftertaste impressions. Attempts have been made to inhibit or remove aftertastes or other negative characteristics of non-sugar sweeteners. For example, combinations of sweeteners and addition of taste inhibitors have been used to attempt to improve the taste characteristics of non-sugar sweeteners. Such approaches have not been entirely successful. Moreover, those approaches typically rely on the use of specific combinations of sweeteners and/or taste inhibitors, and the presence of such reagents in specific and narrow ranges.

Even if such approaches are partially successful in one product, those approaches are generally not applicable to a range of products, because, for example, different products may have different flavors and may possess notes that interact with added inhibitors or sweeteners in unintended ways. For example, even if successfully used in one beverage, some reagent combinations may, when used in other beverages, create products which lack mouthfeel, possess artificially tasting flavor notes, produce a beverage with a sweetness profile that is different from natural sugar, or inadvertently remove flavor notes that are desirable. Such characteristics may complicate production of beverages. In addition, such characteristics may hinder the design of products that may be provided as sugar-free or reduced-calorie versions and that may be sweetened or flavored by consumers to tailor products to individual taste preferences and desired calorie levels. It would be desirable to develop methods of alleviating or reducing negative taste perceptions associated with the aftertaste of artificial sweeteners, to do so using strategies that are readily applicable to a range of sweetness blends, and to provide beverages that provide sweetness delocalization and improved mouthfeel. It is further desirable to provide sweetening or non-sweetening compositions which may be used with different beverages and particularly with sweet beverages that include other flavors, such as bitter, sour and astringent notes.

### SUMMARY

In some embodiments, a composition may comprise phloretin and trilobtain wherein the ratio of phloretin to trilobtain is from about 1:1 to about 3:1. The concentration of phloretin in such a composition may be up to about 150 ppm. In some embodiments, a composition may be a sweetening composition, and may further include one or more high-potency or non-nutritive sweeteners. In other embodiments, a composition may be a non-sweetening composition.

In some embodiments, taste modifiers comprising phloretin and trilobtain may be added to a composition that includes one or more sweetener components. Those sweetener components may, in some embodiments, be sweeteners that typically possess one or more bitter aftertaste notes. For example, sweetener components may include acesulfame-k, steviol glycosides, aspartame, other sweeteners that possess at least one bitter aftertaste, or combinations thereof.

In some embodiments, phloretin and trilobtain may be added to a sweetener or combination of sweeteners. Those sweeteners may initiate several different aftertaste notes, such as metallic, bitter, dry, astringent, other aftertastes or combinations thereof. In some embodiments, the concentration of trilobtain may be sufficient to block the cloying aftertaste perception that may become present upon using phloretin to remove a bitter, metallic, dry or astringent aftertaste. In some embodiments, a combination of phloretin and trilobtain may be used in a beverage where individual use of either phloretin or trilobtain is unsuccessful, such as, for example, where optimization of taste using the modifiers individually yields a cloying aftertaste perception or an astringent/dry perception or results in a beverage without adequate mouthfeel.

In some embodiments, phloretin may be added to a sweet tasting composition at a concentration that suppresses at least one aftertaste of the composition. Phloretin may, in some embodiments, be added at a level that may cause a sweet or cloying aftertaste perception. Trilobtain may be added to the combination of the sweet tasting composition and phloretin, and may be added at levels sufficient to round the sweetness level, to mask the cloying aftertaste perception associated with phloretin, and/or to provide improved mouthfeel.

In some embodiments, taste modifiers may be included in beverages that provide reduced-calorie content as compared to a comparable full-calorie beverage. For example, in some embodiments, a reduced-calorie beverage that provides less than about 70 calories for an 8 ounce portion of the beverage is provided. In some embodiments, a reduced-calorie beverage that provides less than about 60 calories, less than about 40 calories, or less than about 10 calories for an 8 ounce portion of the beverage is provided.

### BRIEF DESCRIPTION OF THE DRAWINGS

FIG. 1 is a flowchart showing a method of adjusting the taste of a composition.

### DETAILED DESCRIPTION

The following terms as used herein should be understood to have the indicated meanings.

When an item is introduced by “a” or “an,” it should be understood to mean one or more of that item.

“Comprises” means includes but is not limited to.

“Comprising” means including but not limited to.

“Having” means including but not limited to.

The term “beverage” as used herein means any drinkable liquid or semi-liquid, including for example flavored water, soft drinks, fruit drinks, slush products, smoothies, coffee-based drinks, tea-based drinks, juice-based drinks, milk-based drinks, dairy-compositions, gel drinks, soy-based drinks, protein drinks, carbonated or non-carbonated drinks, alcoholic or non-alcoholic drinks.

The term “consumable item” means anything that may be orally ingested by a consumer, including without limitation a food, beverage, pharmaceutical composition, nutraceutical composition, vitamin, lozenge, dietary supplement, confection, chewing gum, candy and a combination of any of the foregoing.

The term “high-potency sweetener” means any ingredient that initiates a perception of sweetness at a concentration less than that which would be required for a natural-caloric sweetener. High-potency sweeteners include by way of nonlimiting example acesulfame-k, aspartame, saccharin, stevia, and sucralose, and combinations thereof.

The term “non-nutritive sweetener” refers to any of various materials that initiate a perception of sweetness and provide less than about half the caloric content per unit weight that sucrose does.

The term “intensity of a sweetener” means the rate of change of sweetness level as the concentration of the sweetener is changed.

The term “primary non-nutritive sweetener” refers to any non-nutritive sweetener that provides the largest proportion of total sweetness of any non-nutritive reagent in a sweet composition or beverage.

The term “primary sweetener” refers to any sweetener that provides the largest proportion of total sweetness of any component in a sweet composition or beverage.

The term “sweetener blend” refers to a mixture of two or more sweeteners that may be included in a consumable composition.

This disclosure is directed to taste modifiers, e.g., phloretin and trilobtain, and the use of such taste modifiers to alleviate negative attributes of beverages, or other consumable items. In addition, sweetening compositions comprising phloretin, trilobtain, and one or more sweeteners are described. Sweetening compositions may include, for example, one or more of a nutritive sweetener, high-potency sweetener, non-nutritive sweetener or combinations thereof. In some embodiments, non-sweet or only marginally sweet compositions may comprise phloretin and trilobtain. Such compositions may, in some embodiments, be used to modify the taste properties of a beverage and may be used to provide beverages that are amenable to sweetening or other flavoring adjustment, including adjustment at the point of consumption or by a consumer. Sweetening or non-sweetening compositions may be added to beverages including, by way of nonlimiting example, carbonated or non-carbonated soft drinks, lemon or lemon-lime flavored beverages, dairy compositions, soy-based beverages, protein fortified beverages, cocktails, and various juices, such as, but not limited to, apple, lemon, grapefruit, and tomato based juices. Beverages may include, for example, any of the sweetening compositions or non-sweetening compositions that are described herein or include other compositions as well.

Phloretin or 3-(4-hydroxyphenyl)-1-(2,4,6-trihydroxyphenyl)propan-1-one is a compound that may be classified as a polyphenol, the structure of which is shown below.

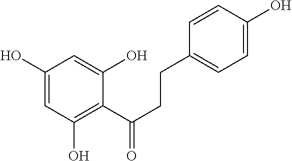 [SMILES: O=C(CCc1ccc(O)cc1)c1c(O)cc(O)cc1O]

Phloretin may also be referred to as a 4-hydroxychalcone and may be present and isolated from various sources including, for example, fruits of the Rosaceae family, which includes apples. Phloretin may also be isolated from apple foliage including leaves and stems, apple peels, and root bark. Phloretin may, in some embodiments, be included in a beverage, and may be added in any amount up to about 150 ppm. In some embodiments, phloretin may be added at about 5 ppm to about 150 ppm. Within this range, phloretin may be at least 10 ppm or at least 25 ppm. Also within this range, phloretin may be up to about 80 ppm or up to about 40 ppm. In some embodiments, phloretin may be included in a beverage at about 5 ppm to about 50 ppm, or about 10 ppm to about 25 ppm, or about 11.5 ppm to about 17.5 ppm. Phloretin, or a combination of phloretin and trilobtain, may be used to provide sweetness delocalization, improve mouthfeel, and block various negative characteristics of sweeteners or other flavoring components in a beverage. For example, phloretin may diminish bitter or astringent beverage tastes.

In some embodiments, phloretin may be included in a sweetening composition which may be added to a beverage. The addition of phloretin may modify the temporal profile for sweetness delivery for which the beverage, upon consumption, may provide. For example, stevia leaf extracts may be used to provide sweetness to a beverage. A beverage sweetened with stevia leaf extract may, upon consumption, provide a temporal profile for delivery of sweetness that may be delayed in the front end, e.g., at early time points, with respect to that of natural sugar, and which may show a tailing sweetness in the back end, e.g., later time points, again with respect to that of natural sugar. The sweetness profile of a beverage sweetened with stevia leaf extract and including phloretin may be shifted to be more similar to that of natural sugar. A beverage with a combination of stevia leaf extract and phloretin may, for example, exhibit increased upfront sweetness and/or mid to back end portions of the temporal profile may be modified, e.g., lingering sweetness may be inhibited. Such behavior, e.g., increased upfront sweetness, modification of the back end of the temporal profile, or both may also be found with combinations of phloretin and other sweeteners, such as, for example, aspartame, which, like stevia leaf extracts, may show lingering sweetness in the back end of the sweetness temporal profile. When used with some sweeteners and at some concentrations, phloretin may, in addition to shifting the temporal profile for sweetness perception and/or diminishing some aftertaste impressions, begin to provide a cloying taste that may be perceived as an artificial taste and such may limit the effectiveness of phloretin as an individual taste modifier. Such effects may be particularly important for some beverages, including, for example, beverages that lack or include only small amounts of nutritive sweeteners, include sweeteners which possess highly bitter aftertastes, include sweeteners which exhibit lingering sweetness, or beverages which exhibit a combination of such characteristics.

Trilobtain, or 1-[4-(beta-D- glucopyranosyloxy)-2,6-dihydroxyphenyl-3-(4-hydroxyphenyl)]-1-propanone is a dihydrochalcone glycoside, the structure of which is shown below.

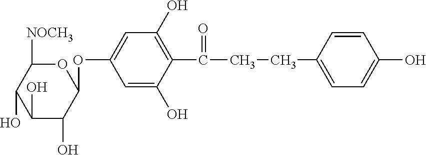

Trilobtain is a compound that at some concentrations, e.g., above about 200 ppm, initiates a detectable sweetness. Trilobtain may be used as a bitter blocker, e.g., to reduce the perception of bitterness. In some embodiments, trilobtain may be used in any amount up to about 150 ppm. When used individually, e.g., above such concentration or in combination with some sweeteners, trilobtain may exhibit an astringent and/or drying aftertaste. In some embodiments, trilobtain may be used in combination with phloretin. Trilobtain may, for example, be used in combination with phloretin to improve the mouthfeel of a beverage or to negate some other negative characteristic of a beverage. In some embodiments, the weight ratio of phloretin to trilobtain may be between about 1:1 to about 3:1, or about 1.5:1 to about 2.5:1, or about 1.8:1 to about 2.2:1, or about 2:1. In some embodiments, the weight ratio of phloretin to trilobtain may be between about 1:1 to about 2:1, or about 1.25:1 to about 1.75:1. In some embodiments, trilobtain may be used at a concentration of between about 5 ppm to about 40 ppm.

In some embodiments of sweetening compositions, the taste modifiers phloretin and trilobtain may be added to a sweetening component that comprises one or more nutritive sweeteners, e.g., such as glucose, fructose, galactose, xylose, lactose, ribose, sucrose, lactulose, lactose, maltose, trehalose, another sugar, or combinations thereof. In some embodiments, nutritive sweeteners may comprise or consist of sugars. Nutritive sweeteners may, in some embodiments, be included at levels such that a portion of a sweetening composition, e.g., designed for inclusion in an about 8 oz soft drink beverage, may include greater than about 60 calories. In some embodiments, a sweetening composition may be configured to provide, upon addition to a soft drink beverage, up to about a 40% reduction in calories as compared to a full-calorie soft drink beverage (about 100 calories per 8 fluid ounces). In other embodiments, a sweetening composition may include nutritive sweeteners at levels that are still further reduced as compared to sweeteners in a full-calorie soft drink beverage. For example, a sweetening composition may, in some embodiments, include nutritive sweeteners and may be configured to provide up to about a 95% reduction in calories as compared to sweeteners in a full-calorie beverage. More generally, a desired reduction in calorie content, e.g., from a full-calorie version of a product may be selected, such as a 10% reduction, 20% reduction, 30% reduction, 50% reduction, or 75% reduction, or 95% reduction. Some of those products, e.g., which may be combined with phloretin, trilobtain, or the combination of both, may include by way of nonlimiting example, those listed in table A below:

TABLE A

| Product | Calories/8 oz |
|---|---|
| Soft Drink (High Calorie) | 120 |
| Tomato Based Beverages | 60 |
| Lemonade | 90 |
| Juice | 130 |
| Tea | 80 |
| Chocolate Drink | 110 |
| Juice Drink | 100 |
| Non-Alcoholic Mixers | 150 |

The data in Table A represent typical full-calorie contents of some of the products which may be combined with taste modifiers described herein. As noted in Table A, some soft drinks, e.g., cream sodas, root beers, some cola flavored beverages and some other soft drinks, may have up to about 120 calories for an 8 ounce portion.

Other sweetening compositions may not include nutritive sweeteners and may, in some embodiments, be substantially free of calories. Compositions that may be only minimally sweet or substantially free of sweetness may, in some embodiments, be used to modify the properties of other beverages, such as, for example, beverages that are sweet, bitter, lack mouthfeel, possess one or more aftertaste, or which possess a combination of the aforementioned characteristics.

Beverages as described herein may include, for example, any of the sweetening compositions or non-sweetening compositions that are described herein. In some embodiments, a beverage may be a carbonated or non-carbonated soft drink that provides above about 60 calories for an 8 ounce portion, and may comprise phloretin at between about 5 ppm to about 150 ppm. In some embodiments, such a beverage may further comprise trilobtain, wherein the weight ratio of phloretin to trilobtain is between about 1:1 to about 3:1. Some carbonated or non-carbonated soft drinks may provide less than about 60 calories and may include taste modifiers comprising a combination of phloretin and trilobtain, wherein phloretin is included at between about 5 ppm to about 50 ppm and wherein the weight ratio of phloretin to trilobtain is between about 1:1 to about 2:1, or about 1.25:1 to about 1.75:1.

In some embodiments, a beverage may be a juice, such as, for example, an apple, lemon, grapefruit, or tomato based juice, and may comprise taste modifiers phloretin and trilobtain, wherein the weight ratio of phloretin to trilobtain is between about 1:1 to about 3:1. In some embodiments, iced tea beverages or other beverages for which consumers typically add a lemon flavor, or other flavors that carry a bitter component, may include a combination of phloretin and trilobtain. Beverages may be provided that include one or more sweeteners and those sweeteners may, upon consumption, deliver a level of sweetness that may be optimized for a consumer or group of consumers. In other embodiments, beverages may be provided that, upon consumption, deliver levels of sweetness that are lower than typically desired by a consumer. For example, a beverage may have a total sweetness that is up to about 80% as sweet as a full-calorie version of the beverage.

In some embodiments, beverages may, for example, be reduced in sweetness and calories, and it may be anticipated that a consumer may choose to add some level of another sweetener, e.g., to customize the beverage to the particular level of sweetness that the consumer desires. For example, some consumers may prefer to drink unsweetened or reduced sweetness tea drinks (e.g., iced tea), lemonades, or other beverages. Such consumers may add other sweeteners to those beverages, e.g., to raise the sweetness level. Any number of different sweeteners may be used, and a typical consumer, e.g., one who is not an expert in beverage flavoring, may not be aware of whether a particular sweetener provides, upon consumption, a particular sweetness temporal profile or whether a particular sweetener, upon consumption, provides a certain aftertaste. As described herein, some compositions, and beverages including such compositions, may provide a taste that is similar to a beverage sweetened with natural sugars, or may provide a taste that is similar to natural sugars when the overall sweetness of a beverage is raised. Such beverages may provide taste properties that are similar to beverages using natural sugars, and may do so irrespective of whether, for example, any of various non-sugar sweeteners or combinations of non-sugar sweeteners are added, e.g., to adjust the overall sweetness. For example, some beverages which include a combination of phloretin and trilobtain, e.g., at a ratio by weight of between about 1:1 to about 3:1, may suppress a metallic, bitter, or dry aftertaste, or combination of aftertastes or suppress other negative characteristics of any added non-sugar sweeteners, and may accomplish such suppression for any of various different non-sugar sweeteners and may accomplish such suppression for a range of overall sweetness levels. Such beverages and compositions may be particularly amenable to sweetness adjustment by a consumer at the location of consumption. In some embodiments, a beverage of a sweetness that is less than what is typically desired by a consumer demographic may include a combination of phloretin and trilobtain, and such materials may be provided with a weight ratio of phloretin to trilobtain that is about 1:1 to about 3:1, or about 1.5:1 to about 2.5:1, or about 1.8:1 to about 2.2:1, or about 2:1. In some embodiments, the weight ratio of phloretin to trilobtain may be between about 1:1 to about 2:1, or about 1.25:1 to about 1.75:1.

Some compositions described herein may be particularly amenable to serve as bases (or concentrates) for providing sweetness or flavoring to beverages, or to serve as bases for modifying the sweetness or flavor of beverages, in environments where various different beverages may be provided from the same base or concentrate. For example, it may be convenient to adjust the sweetness, sweetness profile or remove an unwanted aftertaste from various mixed alcoholic drinks, and to do so rapidly. Such may conveniently be accomplished using a single base that is applied to different drinks. In some embodiments, a base, which may or may not include some amount of alcohol, may be used to enhance or modify the sweetness of a cocktail, such as one flavored with a fruit or vegetable composition, including, for example, a cocktail that includes a tomato flavor. In some embodiments, a base may be used to alleviate a negative characteristic provided in an alcoholic mixed drink. In some embodiments, a base may be used to diminish the aftertaste of a beverage, such as, but not limited to an alcoholic mixed drink, and do so without compromising or while improving the drink's mouthfeel.

In some embodiments, the taste modifiers phloretin and trilobtain may be added to one or more sweeteners that individually may carry a bitter aftertaste. For example, phloretin and trilobtain may be added to a composition that includes one or more steviol glycosides, including substantially pure rebaudioside A, or other steviol glycoside such as rebaudioside A, rebaudioside B, rebaudioside C or dulcoside, including those that may be more bitter than rebaudioside A or enzyme-modified stevia. Other sweeteners that may carry a bitter aftertaste and that also may be added to a combination of phloretin and trilobtain may include, for example, acesulfame-k and aspartame. Such sweeteners may be used either individually or in combination.

In some embodiments, stevia leaf extract may be added to a beverage that contains up to about a 40% reduction in calories from a full-calorie beverage. In some embodiments, stevia leaf extract may be the primary non-nutritive sweetener to augment the perception of sweetness. Such a beverage may, for example, provide about 60 calories for an 8 ounce serving. In such embodiments, stevia leaf extract may be provided to the beverage, or configured in a composition for being provided to a beverage, at a level between about 50 ppm to about 100 ppm. In those embodiments, a bitter aftertaste may be suppressed using phloretin or using phloretin and trilobtain as taste modifiers.

In some embodiments, stevia leaf extract may be added to a beverage that contains more than a 40% reduction in calories from a full-calorie beverage, and may be added, e.g., as the primary non-nutritive sweetener to augment the perception of sweetness. In such embodiments, stevia leaf extract may be provided to the beverage, or configured in a composition for being provided to a beverage, at a level between about 80 ppm to about 600 ppm. Within this range, stevia extract may be up to about 120 ppm, or up to about 180 ppm, or up to about 250 ppm, or up to about 400 ppm. Also within this range, stevia extract may be at least 100 ppm, or at least 150 ppm, or at least 250 ppm. In those embodiments, a bitter aftertaste of the beverage may be suppressed using a combination of phloretin and trilobtain. Use of those taste modifiers individually may, in some embodiments, provide a beverage with either cloying aftertaste and/or unacceptable mouthfeel.

In some embodiments, the taste modifiers phloretin and trilobtain may be added to one or more sweeteners that individually may initiate a dry aftertaste. For example, phloretin and trilobtain may, in some embodiments, be added to a composition that includes sucralose. Such a composition, e.g., including phloretin, trilobtain and one or more sweeteners that initiate a dry aftertaste, may be added to a beverage, a beverage of low sweetness, or used as a sweetening composition.

In some embodiments, the taste modifiers phloretin and trilobtain may be added to one or more sweeteners that individually may initiate an astringent aftertaste. For example, phloretin and trilobtain may, in some embodiments, be added to a composition that includes luo-han fruit extract. Such a composition e.g., including phloretin, trilobtain and one or more sweeteners that may initiate an astringent aftertaste, may be added to a beverage, a beverage of low sweetness, or used as a sweetening composition.

In some embodiments, the taste modifiers phloretin and trilobtain may be added to one or more sweeteners that individually or in combination may initiate an aftertaste significantly different from sucrose. For example, phloretin and trilobtain may, in some embodiments, be added to a composition that includes artificial high-potency sweeteners such as sucralose, aspartame, acesulfame-potassium, neotame, other artificial high-potency sweeteners, or combinations thereof. Addition of phloretin and trilobtain may act to suppress a metallic, bitter, dry, astringent, or other negative taste perception that may otherwise, i.e., in the absence of those taste modifiers, be present in a beverage. In some embodiments, the combination of phloretin and trilobtain may act to suppress one or more of the aforementioned taste perceptions and the synergistic effect of the combination of phloretin and trilobtain may provide a beverage without the presence of a cloying aftertaste.

In addition to the presence of various sweeteners, e.g., high-potency sweeteners or non-nutritive sweeteners, the aftertaste of a beverage may also be related to other flavors or characteristics of a beverage. For example, flavors in a beverage, including, for example, sour, bitter, salty, or other flavors, may influence a consumer's perception of aftertaste notes. Bitterness, for example, may influence the perception of off-notes, and may involve a complex distribution of receptors in the mouth. In addition, for some beverages, such as coffee, chocolate beverages, or some juice beverages, it may be desirable to maintain some level of natural bitterness but inhibit other bitter notes. For some of those beverages, in some embodiments, the only taste modifiers that may be added may be phloretin, trilobtain or a combination of phloretin and trilobtain. When used in combination, phloretin and trilobtain may, in some embodiments, be present in a weight ratio of phloretin to trilobtain that is from about 1:1 to about 3:1. More generally, the use of taste modifiers that include or consist of phloretin and trilobtain may, in some embodiments, be included in a beverage, sweetening, or non-sweetening composition. Lemon-flavored beverages and some carbonated soft drinks, which may have both bitter and sweet components, may be particularly difficult to balance. In some embodiments, the taste modifiers phloretin and trilobtain may be included in a diet lemon-based beverage, and the taste modifiers may be configured such that incorporation of the modifiers in the beverage may not negatively affect lemon-lime characteristics of the beverage.

In some embodiments, reduced-calorie sweeteners and consumable items that have taste characteristics similar to those exhibited by full-calorie consumables are provided. Such reduced-calorie sweeteners and consumable items may include a combination of high-potency sweeteners and one or more natural sweeteners. Improvements in taste for the reduced-calorie consumable items described in this disclosure, including increasing the similarity of their taste to full-calorie consumables, may, in some embodiments, be related to the suppression of at least one negative characteristic commonly associated with other consumables designed with lower calorie content than full-calorie consumables. By way of non-limiting example, some negative characteristics commonly associated with other lower calorie content consumable items may include inadequate overall sweetness, excessive overall sweetness, lacking upfront sweetness, lingering sweetness, lacking overall flavor, having limited or improper mouthfeel, having off-taste properties such as bitter, metallic or licorice-like aftertaste, and combinations of the foregoing.

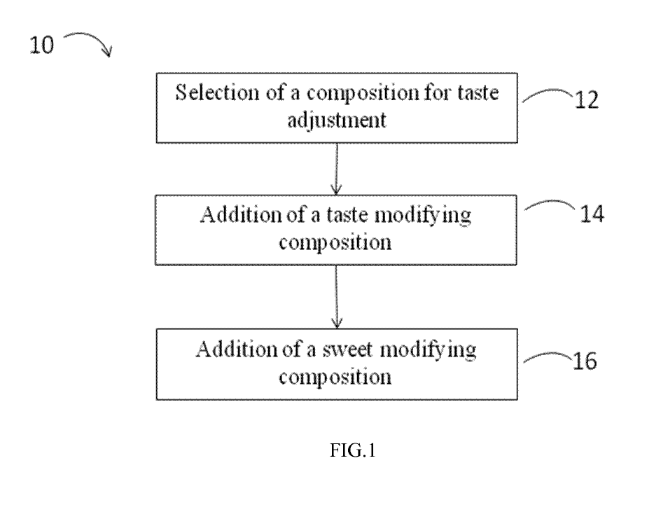

A method 10 of adjusting the taste of a consumable composition or intermediate intended for eventual consumption is shown in FIG. 1. In a step 12 the composition intended for taste adjustment may be selected. Adjustment may be performed by a manufacturer or a supplier involved in production and distribution of the consumable item. In some embodiments, adjustment of the selected composition may be performed by a consumer of the taste adjusted composition. The composition selected for taste adjustment may include a level of sweetness that is ideal for a majority of consumers or for a majority of consumers of a particular demographic. For example, the composition may be a fully-sweetened beverage. Alternatively, the composition may be a non-sweetened composition or may be only partially sweetened as compared to the level of sweetness that is ideal for a majority of consumers. In some embodiments, the selected composition may comprise one or more sweeteners including but not limited to high-potency sweeteners, and the one or more sweeteners may provide to the selected composition one or more aftertastes. Aftertastes associated with the composition selected for taste adjustment may, by way of nonlimiting example, include a bitter aftertaste, a metallic aftertaste, a dry aftertaste, an astringent aftertaste, or combinations thereof. In some embodiments, the composition selected for adjustment may possess a mouthfeel that is ideal or may be lacking in one or more attributes related to mouthfeel.

In a step 14, a taste modifying composition may be added to the composition selected for taste adjustment. Following the addition of the taste modifying composition, the resultant composition may, in some embodiments, include a weight ratio of phloretin to trilobtain of about 1:1 to about 3:1. In some embodiments, the taste modifying composition may comprise a combination of phloretin and trilobtain in a ratio between about 1:1 to about 3:1 by weight. The taste modifying composition may be added in any convenient form, such as, for example, in the form of a solid, a liquid, or dispersion. Phloretin and trilobtain may be added together; that is, the phloretin and trilobtain may be pre-mixed in the taste modifying composition, and it may be convenient to do so. For example, if taste adjustment is performed by a consumer, a packet including phloretin and trilobtain at a desired ratio may be desirable. However, in some embodiments, phloretin and trilobtain may be added separately to the composition selected for taste adjustment.

In a step 16, a sweet modifying composition may be added to the composition. In some embodiments, any of a range of sweeteners may be used in step 16. For example, a consumer may choose to add any of various available sweetener packets. A typical consumer may not be aware of whether the addition of one or more available sweeteners balances or unbalances the sweetness profile and may be unaware how the addition affects the aftertaste of the resultant composition. Advantageously, prior addition of phloretin and trilobtain may serve to alleviate negative attributes provided from a range of sweeteners. Therefore, the effects on beverage taste from the presence or addition of any particular combination of sweeteners—from either or both of step 12 and step 16 of method 10—and the effects of inadvertent unbalancing of the sweetness profile may be lessened. Therefore, method 10, while not limited to adjustment by individual consumers, is particularly well suited for individual adjustment by consumers.

A taste modifying composition (such as may be added in a step 14) may be sweetened or may be unsweetened. Therefore, in some embodiments, the addition of a taste modifying composition may serve both to add taste modifiers and may further provide sweetness to a composition selected for taste adjustment. The addition of a sweetened taste modifying composition may be used in addition to or alternatively to addition of another sweetening composition.

Moreover, in some embodiments, a composition selected for taste adjustment may already include either or both of phloretin and trilobtain. For example, in some embodiments, a composition may be a sweetened, non-sweetened, or partially-sweetened beverage or beverage intermediate that includes one or both of the aforementioned taste modifiers. Such a composition may be intended for individual adjustment by a consumer, for example, if the consumer decides that the composition lacks sweetness. In some embodiments, a composition may be a sweetened, non-sweetened, or partially-sweetened beverage or beverage intermediate that includes a lemon or lemon-lime flavor and/or either or both of bitter and sour flavors. The individual taste preference of consumers for some of those beverages may be varied and it may be difficult to provide a beverage (without adjustment) that is suitably liked by all consumers. For example, some consumers may desire a sweetness level that is as great as about 50% higher than typically desired by a majority of consumers. In addition, some consumers may, for example, desire a sweetness level that is about 50% lower than typically desired by a majority of consumers. The use of phloretin and trilobtain in beverages may facilitate customization of sweetness by individual consumers, such as, for example, customization within the sweetness levels described above, while minimizing or preventing the risk that such a consumer may inadvertently add an undesired attribute to the final beverage that is consumed.

In some embodiments, a beverage may be provided that includes a first sweetener or sweetener blend as well as a combination of the taste modifiers phloretin and trilobtain. The amounts of phloretin and trilobtain may be sufficient such that addition of a second sweetener or sweetener blend—including one or more of a sweetener that typically possesses an aftertaste—provides a beverage that is substantially free of the aftertaste that in the absence of the taste modifiers would have been present. An individual may, for example, choose to add a second sweetener or sweetener blend that possesses at least one of a bitter aftertaste, metallic aftertaste, dry aftertaste, astringent aftertaste, or a combination of those aftertastes. By way of nonlimiting example, one or more of the aforementioned aftertastes may be characteristic of sweeteners such as acesulfame-potassium, aspartame, stevia extract, luo-han fruit extract, and combinations thereof—each of which may, in some embodiments, be added as a second sweetener (or part of a sweetener blend) to a beverage.

In some embodiments, a beverage may include a first sweetener or sweetener blend that provides upon consumption an equivalent sweetness that is between about 50% to about 100%, for example, or other suitable percentage, of that of a fully-sweetened beverage, and the beverage may further include phloretin at between about 5 ppm to about 50 ppm and trilobtain in an amount sufficient to yield a ratio of phloretin to trilobtain of about 1:1 to about 3:1 by weight. Such a beverage may be configured such that addition of an amount of a second sweetener or sweetener blend, for example, to provide a total sweetness desired by a consumer, may be accomplished without addition of an aftertaste.

In some embodiments, a beverage may include a first sweetener or sweetener blend and phloretin and trilobtain in amounts sufficient to decrease an aftertaste that may be provided by a second sweetener or sweetener blend even if the total sweetness provided by sweeteners in the beverage (for example, after addition of the second sweetener or sweetener blend) ranges from about 50% lower than typically desired by a majority of consumers to about 50% higher than typically desired by a majority of consumers. For example, some fruit-flavored beverages may be characterized by an ideal total sweetness level which would be provided by about 25 grams of sucrose in an 8 fluid ounce serving of a beverage if the beverage were sweetened substantially with sucrose. That is, the ideal sweetness for a beverage may be characterized by a sucrose equivalent sweetness of about 25 grams per 8 fluid ounces. Amounts of phloretin and trilobtain may be sufficient to decrease an aftertaste that may be provided by the second sweetener even if the total sweetness provided by sweeteners in the fruit-flavored beverage provides a sucrose equivalent sweetness of between about 12 grams of sucrose to about 38 grams of sucrose per 8 fluid ounces.

Other beverages, including other fruit-flavored beverages, may be characterized by the same or different ideal sweetness levels. As understood by those of ordinary skill in the art, the particular amounts of sucrose (or others sweeteners) appropriate for providing a desired total level of sweetness may be related to the type of beverage and/or the variety of flavors included in the beverage. As described herein, the taste modifiers phloretin and trilobtain may be included or added to beverages with a range of ideal sweetness levels and including any of various flavors.

Some embodiments may include high-intensity, high-potency, non-nutritive, reduced-calorie, or other sweeteners in the composition. Without being limited to particular sweeteners, representative categories and examples include:

(a) water-soluble sweetening agents such as monellin, steviosides, stevia leaf extract, enzyme modified stevia, monatin, lo han quo or derivatives of lo han quo, glycyrrhizin, dihydroflavenol, and sugar alcohols such as sorbitol, mannitol, maltitol, and L-aminodicarboxylic acid aminoalkenoic acid ester amides, such as those disclosed in U.S. Pat. No. 4,619,834, which disclosure is incorporated herein by reference, and a combination comprising any of the foregoing;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and a combination comprising any of the foregoing;

(c) dipeptide based sweeteners, such as L-aspartic acid derived sweeteners, such as L-aspartyl-L-phenylalamine methyl ester (Aspartame) and materials described in U.S. Pat. No. 3,492,131, L-alpha-aspartyl-N-(2,2,4,4-tetramethyl-3-thietanyl)-D-alaninamide hydrate (Alitame), N—[N-(3,3-dimethylbutyl)-L-aspartyl]-L-phenylalanine 1-methyl ester (Neotame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and a combination comprising any of the foregoing;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include: 1-chloro-1′-deoxysucrose; 4-chloro-4-deoxy-alpha-D-galactopyranosyl-alpha-D-fructofurano side, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro 1′,6′-dideoxysucrose; 4-chloro-4-deoxy-alpha-D-galactopyranosyl-1,6-dichloro-1,6-dideoxy-beta-D-1-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-1-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideo-xy-beta-D-fructofuranoside, or 4,6,1′,6′-tetrachloro-4,6,1′,6′-tetradeoxygalacto-sucrose; and 4,6,1′,6′-tetradeoxy-sucrose, and a combination comprising any of the foregoing;

(e) protein-based sweeteners such as thaumaoccous danielli (Thaumatin I and II); and

(f) the naturally occurring sweetener monatin (2-hydroxy-2-(indol-3-ylmethyl)-4-aminoglutaric acid) and its derivatives, lo ban quo and its derivatives.

Many sweetening agents, including some previously discussed, can be categorized as natural sweeteners, for example L-alanine, arabinose, banana extract, carob, cellobiose, corn syrup (including high fructose corn syrup and corn syrup solids), dextrin, dextrose, Dioscoreophyllum cumminsii (Serendipity Berry), erythritol, fructooligosaccharide (FOS), fructose, (including “liquid fructose”), galactose, glucose, glycine, glycyrrhizin, honey, inulin, isomalt, invert sugar, lactitol, lactose, lo han (lo han kuo; lo han guo; lohan guo; lohan kuo), maltitol, maltodextrin, maltose, mannitol, mannose, monatin, maple syrup, molasses, partially hydrogenated starch hydrolysate, partially hydrolyzed starch, polydextrose solution, polyglycitol, raftilose, miraculin (Richadella dulcifica (Miracle Berry)), ribose, rice syrup, sorbitol, sorbose, stevia, stevio side, sucralose, sucrose, sugar beets, (dehydrated filaments of), D-tagatose, thaumatin, xylitol, xylose, sucromalt, and a combination comprising any of the foregoing.

The sweetening agent can be used individually or as mixtures.

The sweetening agents can be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and a combination comprising any of the foregoing.

Additional natural flavors and colors may, in some embodiments, be added. Flavoring agents include those flavors known to one of ordinary skill in the art, such as natural flavors, artificial flavors, spices, seasonings, and the like. Exemplary flavoring agents include synthetic flavor oils and flavoring aromatics and/or oils, oleoresins, essences, distillates, and extracts derived from plants, leaves, flowers, fruits, and so forth, and a combination comprising any of the foregoing.

Exemplary flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, prune, raisin, cola, guarana, neroli, pineapple, apricot, banana, melon, apricot, ume, cherry, raspberry, blackberry, tropical fruit, mango, mangosteen, pomegranate, papaya and so forth. Additional exemplary flavors imparted by a flavoring agent include a milk flavor, a cream flavor, a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamon flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

In some embodiments, other flavoring agents include aldehydes and esters such as cinnamyl acetate, cinnamaldehyde, citral diethylacetal, dihydrocarvyl acetate, eugenyl formate, p methylamisol, and so forth. Further examples of aldehyde flavorings include acetaldehyde (apple), benzaldehyde (cherry, almond), anisic aldehyde (licorice, anise), cinnamic aldehyde (cinnamon), citral, i.e., alpha citral (lemon, lime), neral, i.e., beta citral (lemon, lime), decanal (orange, lemon), ethyl vanillin (vanilla, cream), heliotrope, i.e., piperonal (vanilla, cream), vanillin (vanilla, cream), alpha amyl cinnamaldehyde (spicy fruity flavors), butyraldehyde (butter, cheese), valeraldehyde (butter, cheese), citronellal (modifies, many types), decanal (citrus fruits), aldehyde C 8 (citrus fruits), aldehyde C 9 (citrus fruits), aldehyde C 12 (citrus fruits), 2 ethyl butyraldehyde (berry fruits), hexenal, i.e., trans 2 (berry fruits), tolyl aldehyde (cherry, almond), veratraldehyde (vanilla), 2,6 dimethyl 5 heptenal, i.e., melonal (melon), 2,6 dimethyloctanal (green fruit), and 2 dodecenal (citrus, mandarin), and the like. Generally any flavoring or food additive such as those described in Chemicals Used in Food Processing, publication 1274, pages 63-258, by the National Academy of Sciences, can be used.

In some embodiments, the composition may include optional additives such as antioxidants, amino acids, caffeine, coloring agents (“colorants”, “colorings”), emulsifiers, flavor potentiators, food-grade acids, minerals, micronutrients, plant extracts, phytochemicals (“phytonutrients”), preservatives, salts including buffering salts, stabilizers, thickening agents, medicaments, vitamins, and a combination comprising any of the foregoing additives. Those of ordinary skill in the art will appreciate that certain additives may meet the definition or function according to more than one of the above-listed additive categories.

Compositions described here can, optionally, further include flavor potentiators. In some embodiments, potentiators may be designed to intensify, supplement, modify, or enhance the perception of flavor, sweetness, tartness, umami, kokumi, saltiness, and combinations thereof.

Examples of flavor potentiators, also known as taste potentiators, include neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), sugar acids, potassium chloride, sodium acid sulfate, hydrolyzed vegetable proteins, hydrolyzed animal proteins, yeast extracts, adenosine monophosphate (AMP), glutathione, nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt), sugar beet extract (alcoholic extract), sugarcane leaf essence (alcoholic extract), curculin, strogin, mabinlin, gymnemic acid, hydroxybenzoic acids, 3-hydrobenzoic acid, 2,4-dihydrobenzoic acid, citrus aurantium, vanilla oleoresin, sugarcane leaf essence, maltol, ethyl maltol, vanillin, licorice glycyrrhizinates, compounds that respond to G-protein coupled receptors (T2Rs and T1Rs), G-protein coupled receptors (T2Rs and T1Rs), and taste potentiator compositions that impart kokumi, as disclosed in U.S. Pat. No. 5,679,397 to Kuroda et al., herein incorporated by reference, and combinations thereof. “Kokumi” refers to materials that impart “mouthfulness” and “good body.”

Sweetener potentiators, which are a type of flavor potentiator, enhance the taste of sweetness. In some embodiments, exemplary sweetener potentiators include mono ammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, sugar beet extract, neotame, thaumatin, neohesperidin dihydrochalcone, hydroxybenzoic acids, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs), G-protein coupled receptors (T2Rs and T1Rs), hydroxybenzoic acid amides as disclosed in WO 2006/024587 to Ley et al., hydroxydeoxybenzoins (hydroxyl-substituted 1,2-diphenylethanones) as disclosed in WO2006/106023 to Ley et al., and combinations thereof.

Additional examples of potentiators for the enhancement of salt taste include acidic peptides, such as those disclosed in U.S. Pat. No. 6,974,597, herein incorporated by reference. Acidic peptides may include peptides having a larger number of acidic amino acids, such as aspartic acid and glutamic acid, than basic amino acids, such as lysine, arginine and histidine. The acidic peptides are obtained by peptide synthesis or by subjecting proteins to hydrolysis using endopeptidase, and if necessary, to deamidation. Suitable proteins for use in the production of the acidic peptides or the peptides obtained by subjecting a protein to hydrolysis and deamidation include plant proteins, (e.g. wheat gluten, corn protein (e.g., zein and gluten meal), soybean protein isolate), animal proteins (e.g., milk proteins such as milk casein and milk whey protein, muscle proteins such as meat protein and fish meat protein, egg white protein and collagen), and microbial proteins (e.g., microbial cell protein and polypeptides produced by microorganisms).

The pH of beverages may also be modified by the addition of food-grade compounds such as ammonium hydroxide, sodium carbonate, potassium carbonate, sodium bicarbonate, and the like, and a combination comprising any of the foregoing. Additionally, the pH of the beverage can be adjusted by the addition of carbon dioxide.

### EXAMPLES

### Example 1

A series of sucrose containing beverages was made by mixing the listed ingredients as shown in Table 1. Water used in all beverages described herein was specifically purified prior to use by processes well-known in the art such as filtration, deionization, distillation, or reverse osmosis. Evaluation of the samples was performed using evaluation by sensory panelists. Beverage sampling comprised of taking an about 10 mL portion of the beverage into the mouth, holding the sample in the mouth, and rating the sweetness time intensity profile, aftertaste, and mouthfeel for each sample.

TABLE 1

| | Sample Number (All values in grams per liter) | | | | |
|---|---|---|---|---|---|
| | Sample | Sample | Sample | Sample | Sample |
| Ingredient | 1 | 2 | 3 | 4 | 5 |
| Water | 899 | 929 | 929 | 929 | 929 |
| Sucrose | 100 | 70 | 70 | 70 | 70 |
| Stevia Leaf | | 0.08 | 0.08 | 0.08 | 0.08 |
| Extract | | | | | |
| Citric Acid | 1 | 1 | 1 | 1 | 1 |
| Phloretin | | | 0.05 | 0.1 | 0.05 |
| Trilobatin | | | | | 0.025 |

Sample 1 comprises about 10° Bx sucrose and may be considered a control sample. The control sample may be representative of full-calorie beverages sweetened with sucrose sugar, the sweetness characteristics of which are generally considered by consumers to be ideal. Beverage Sample 2 includes about 30% lower concentration of sucrose than does the control. To compensate for the lowered contribution of sweetness afforded from natural sugar, Sample 2 includes about 0.08 gm/l (or about 80 ppm) of stevia leaf extract. Stevia leaf extract served as the principal non-sugar sweetener in each of Samples 2-5 in Example 1. The overall sweetness of Sample 2 is roughly similar to Sample 1. However, Sample 2 illustrates at least some negative characteristics commonly associated with beverages that lack sugar. For example, some individuals who consumed Sample 2 noted a thinner mouthfeel and further characterized the sample as leaving a somewhat dry aftertaste in the mouth following consumption of the beverage. In addition, Sample 2 was characterized as having a perceptible bitter aftertaste. While overall sweetness was deemed to be about similar to Sample 1, some panelists considered the sample to have a lowered upfront sweetness. As may be typically found for solutions of stevia leaf extract, Sample 2 was characterized as having a somewhat slower onset of sweetness and somewhat elevated sweetness at longer times. That is, the sweetness temporal profile of Sample 2 was not perfectly matched to that of the control Sample 1.

In Sample 3, the taste modifier phloretin was added at a level of about 50 ppm. Aftertaste characteristics noted in Sample 2, e.g., sensation of dryness and bitterness, were reduced by addition of phloretin. However, some panelists described the aftertaste as cloying aftertaste perception. The sweetness profile of Sample 3 was more similar (but not identical) to the control sample than found in Sample 2. That is, Sample 3 showed a modified sweetness profile, e.g., the sweetness was modified in the mid to back end of the sweetness temporal profile, as compared to Sample 2. Such behavior, i.e., modification of the back end of the temporal profile, for beverages that use phloretin as a taste modifier, may also be found with sweeteners, such as aspartame, which, like stevia leaf extract, show a delayed temporal profile with respect to sucrose.

In Sample 4, the concentration of phloretin was increased further, i.e., above the level of Sample 3, to a value of about 100 ppm. Sample 4 was characterized as having an increased mouthfeel. In addition, the sweetness profile was more similar to the control than was found in Sample 3. For example, Sample 4 showed more upfront sweetness. While the temporal profile of Sample 4 was more similar to the control than Sample 3, the increased concentration of phloretin was found to result in the addition of a cloying aftertaste perception, particularly at the back end of the temporal profile. More generally, addition of phloretin, as an individual taste modifier, at levels to balance the sweetness temporal profile of stevia leaf extract was only partially successful. For example, in Sample 4, raising the concentration of phloretin, to approximately match the mid to back end regions of the sweetness temporal profile of natural sugar, was not achieved until a cloying aftertaste perception became present. Reduction of sucrose levels further than that in Example 1, that is, to less than 70 gm/l such as about 60 gm/l, may demand a greater compensation of sweetness with stevia leaf extract, such as by increasing levels of stevia leaf extract above about 80 ppm, which thus may demand greater amounts of taste modifiers, e.g., to alleviate such samples from possessing any aftertaste associated with stevia. In such samples, e.g., with greater reduction of sucrose, if phloretin was used individually as a taste modifier, e.g., without trilobtain, optimization of phloretin concentration may result in the persistence of cloying aftertaste.

In Sample 5, trilobtain was added at a concentration of about 25 ppm and phloretin added at about 50 ppm. The sweetness profile of Sample 5 was similar to that of natural sugar, e.g., up-front sweetness was high and a rounded natural sweetness profile was observed. The cloying aftertaste perception present in Sample 4 was not present in Sample 5. That is, addition of trilobtain and phloretin in combination significantly improved various taste characteristics of Sample 5, e.g., mouthfeel, upfront sweetness and taste perceptions in the mid to back end portion of times, and did so without initiation of a cloying aftertaste perception.

### Example 2

A series of beverages was made by mixing the listed ingredients as shown in Table 2.

TABLE 2

| | Sample Number (All values in grams per liter) | | | | |
|---|---|---|---|---|---|
| | Sample | Sample | Sample | Sample | Sample |
| Ingredient | 1 | 6 | 7 | 8 | 9 |
| Water | 899 | 998 | 998 | 998 | 998 |
| Sucrose | 100 | 0 | 0 | 0 | 0 |
| Citric Acid | 1 | 1 | 1 | 1 | 1 |
| High-Potency | | 0.51 | 0.51 | 0.51 | 0.51 |
| Sweeteners | | | | | |
| Phloretin | | | 0.05 | 0.1 | 0.05 |
| Trilobatin | | | | | 0.025 |

Sample 1 is identical to that illustrated in Table 1 and again may be representative of full-calorie beverages sweetened with sucrose. Sample 6 included a sweetening blend of artificial high-potency sweeteners including sucralose, aspartame and acesulfame-K. The sweetening blend of Sample 6 included high-potency sweeteners that may be characterized as possessing a bitter aftertaste and also high-potency sweeteners that may initiate a dry aftertaste. Sample 6 was described by panelists as having multiple aftertaste off notes, including bitterness, dryness in the back end and astringency. The artificial high-potency sweetener system was further described by panelists as having a typical aftertaste associated with high-potency sweeteners.

In Sample 7, the taste modifier phloretin was added at a level of about 50 ppm. Addition of phloretin improved the sweetness profile, e.g., panelists described fuller sweetness and an increasing proportion of sweetness in the front end of the temporal profile. Aftertaste notes that were present in Sample 6 were significantly decreased. Addition of phloretin in Sample 7 generally resulted in a sweetness that was more similar to natural sugar, however, mouthfeel was less than ideal and syrup-like notes that generally are present with natural sugar were not ideal. In Sample 8, the concentration of phloretin was increased to about a level of 100 ppm. Syrup notes typical of natural sugars were accentuated and the overall sweetness of the sample, e.g., overall perception of sweetness was improved. As the phloretin concentration was increased, some aftertaste notes, e.g., bitterness and dryness, were substantially negated. However, although not as distinct as in Sample 4, some cloying aftertaste perceptions were present.

In Sample 9, trilobtain was added at a concentration of about 25 ppm and phloretin added at about 50 ppm. The overall mouthfeel, sweetness, and temporal profile for sweetness were very similar to that of natural sugar. In particular, panelists noted a high level of upfront sweetness, rounded sweetness profile, and no detectable aftertaste.

### Example 3

A series of beverages was made by mixing the listed ingredients as shown in Table 3.

TABLE 3

| | Sample Number (All values in grams per liter) | | | | |
|---|---|---|---|---|---|
| | Sample | Sample | Sample | Sample | Sample |
| Ingredient | 1 | 10 | 11 | 12 | 13 |
| Water | 899 | 978 | 978 | 978 | 978 |
| Sucrose | 100 | 5.0 | 5.0 | 5.0 | 5.0 |
| Erythritol | | 15.0 | 15.0 | 15.0 | 15.0 |
| Stevia Leaf | | 0.64 | 0.64 | 0.64 | 0.64 |
| Extract | | | | | |
| Luo-Han Fruit | | 0.03 | 0.03 | 0.03 | 0.03 |
| Extract | | | | | |
| Citric Acid | 1.0 | 1.0 | 1.0 | 1.0 | 1.0 |
| Pectin | | 0.2 | 0.2 | 0.2 | 0.2 |
| Phloretin | | | 0.05 | 0.1 | 0.05 |
| Trilobatin | | | | | 0.025 |

Sample 1 is identical to that illustrated in Table 1 and again may be representative of full-calorie beverages sweetened with sucrose sugar. Sample 10 included a combination of natural high intensity sweeteners, e.g., stevia leaf extract and luo-han fruit extract, and included a small amount of sucrose (about 5 gm/l) and erythritol (about 15 gm/l).

Sample 10 was characterized as having a generally appealing sweetener profile with some off aftertaste. Sample 10 was lacking in upfront sweetness as compared to control Sample 1. Sample 10 was furthermore somewhat lacking in overall mouthfeel. In Samples 11 and 12, phloretin was added at 50 ppm and 100 ppm, respectively. In general, while syrup characteristics and some shift in sweetness to the front end was noted, each of those samples showed lower mouthfeel than did the control.

In Sample 13, the same phloretin and trilobtain concentration was used as in Sample 5 and Sample 9, e.g., 50 ppm of phloretin and 25 ppm trilobtain. Like Sample 5 and Sample 9, the combination of phloretin and trilobtain provided superior mouthfeel, an upfront sweetness similar to natural sugar and a more rounded sweetness profile. Again, the addition taste modifiers in combination provided a smooth, sugar like profile without addition of aftertaste notes.

### Example 4

In Example 4, an all natural reduced-calorie lemonade beverage was prepared. The reduced-calorie lemonade beverage provided about 15 to about 25 calories for a 16 ounce serving. A natural lemon base was first prepared and used to flavor each beverage in Example 4. The lemon base included water, concentrated lemon juice (about 0.29% w/w), lemonade flavor, pectin, and a citric acid buffer system. The pH of the lemon base and all beverages created therefrom was between about 2.0 and about 4.2. A combination of sweeteners including about 15 gm/l erythritol and 355 ppm stevia leaf extract was added to the lemon base to produce a naturally lemon-flavored sweetened beverage without taste modifiers. The beverage provided a total sweetness that was similar to a full-calorie lemon-flavored beverage. The sweetness profile showed some lack of upfront sweetness and additionally mouthfeel were found to be lacking. Addition of taste modifiers to the beverage, e.g., about 50 ppm phloretin and about 25 ppm trilobtain, improved the beverage mouthfeel and provided a beverage with high quality syrup notes that were present in upfront portions of time. Overall, the sweetness profile was more rounded, and the beverage with taste the modifiers phloretin and trilobtain provided good mouthfeel and upfront sweetness that was similar to that provided by natural sugars.

### Example 5

The same lemon base as used in example 4 was used to create a series of lemon-flavored beverages in Example 5. The lemon-flavored beverages in Example 5 included several different sweetener blends, as shown in Table 4.

TABLE 4

| | SAMPLE (all values in g/l) | | | | | | | | | |
|---|---|---|---|---|---|---|---|---|---|---|
| Ingredient | A | B | C | D | E | F | G | H | I | J |
| Erythritol | 15 | 15 | 15 | 15 | 15 | 15 | 15 | 15 | 15 | 15 |
| Stevia Leaf | 0.29 | 0.275 | 0.3 | 0.3 | 0.31 | 0.31 | 0.355 | 0.355 | 0.3 | 0.26 |
| Extract | | | | | | | | | | |
| Trilobatin | | 0.02 | | 0.025 | | 0.02 | | 0.25 | | 0.02 |
| Phloretin | | 0.04 | | 0.05 | | 0.04 | | 0.05 | | 0.04 |

The beverage sweetness profile, e.g., time course of sweetness delivery, was more similar to that of natural sugars in Samples B, D, F, H, and J. Moreover, the samples that included both trilobtain and phloretin did not exhibit bitter or dry aftertaste components. More generally, as may be seen from Example 5 and other examples herein, beverages with trilobtain and phloretin exhibit improved taste characteristics over counterpart beverages, and such improvement is maintained over a range of different total sweetness levels. For example, even if total sweetness of beverages was found to be slightly high, samples with the combination of trilobtain and phloretin showed improved taste characteristics over other samples which did not include the taste modifiers.

### Example 6

In Example 6, a series of beverages was made by mixing phloretin or a combination of phloretin and trilobtain with a carbonated lemon-lime flavored base. The beverage base was configured to provide upon consumption less than 5 calories per 8 fluid ounces. The composition of the carbonated lemon-lime flavored base is shown in Table 5.

TABLE 5

| | Beverage |
|---|---|
| Ingredient | (All values in wt %) |
| Water | 99.54 |
| Medium Invert Sugar | 0.12 |
| Natural Sweetener | 0.06 |
| Flavor | 0.1 |
| Citric Acid | 0.12 |
| Sodium Benzoate | 0.03 |
| Potassium Citrate | 0.05 |

Evaluation of samples prepared from the beverage base was performed using consumer testing. All samples were served blind and provided in a volume of about 4 ounces. The samples were served following a modified block design to minimize testing bias. A total of 147 consumers were used for the product testing experiments. Participants completed questionnaires for each product. In the questionnaire consumers were asked to evaluate characteristics of the beverage samples including overall aroma, lemon-lime aroma, overall flavor, lemon-lime flavor, sweetness, carbonation, mouthfeel, and aftertaste pleasantness. Characteristics were ranked on a 9-point scale, with higher values corresponding to an improvement in the characteristic.

The following lemon-lime flavored beverages were prepared by addition of ingredients to the beverage base and evaluated by the consumer testing group.

Sample A: Carbonated lemon-lime flavored Base 1 (control sample)

Sample B: Carbonated lemon-lime flavored Base 1, 7.5 ppm phloretin, and 7.5 ppm trilobtain

Sample C: Carbonated lemon-lime flavored Base 1 and 3 ppm phloretin

Sample D: Carbonated lemon-lime flavored Base 1, 10.5 ppm phloretin, and 7.5 ppm trilobtain

The descriptive results of the consumer testing of samples A-D are summarized in Table 6.

TABLE 6

Sample Designation

| | A | B | C | D |
|---|---|---|---|---|
| Overall Aroma | 6.2 | 6.5 | 6.4 | 6.5 |
| Lemon-Lime Aroma | 6.3 | 6.5 | 6.4 | 6.6 |
| Overall Flavor | 6.3 | 6.3 | 6.4 | 6.4 |
| Lemon-Lime Flavor | 6.4 | 6.4 | 6.4 | 6.6 |
| Sweetness | 6 | 6.2 | 6.3 | 6.3 |
| Carbonation | 6.2 | 6.4 | 6.6 | 6.4 |
| Mouthfeel | 6.1 | 6.3 | 6.5 | 6.3 |
| Aftertaste Pleasantness | 5.8 | 5.9 | 6.1 | 6.2 |

In general, the blend of sweetening components used with the base was selected to provide sweetening characteristics as close to the ideal sweetness as possible provided the limitations of a diet beverage. Sample A (which did not include either of the taste modifiers phloretin or trilobtain) may be considered a control sample. Sample A included a combination of natural sweeteners which provide near ideal sweetness. However, as commonly present in diet beverages, the combination of sweeteners provided limited mouthfeel and possessed slightly less than ideal aftertaste notes. Addition of the taste modifiers phloretin or the combination of phloretin and trilobtain provided a beverage with improved mouthfeel—offsetting deficiencies in this attribute for the diet beverage—and provided beverages with an aftertaste pleasantness that was at least on par or better than the control sample. In addition, a number of attributes characterized for the beverages were associated with lemon-lime characteristics of the beverages. For example, included among the lemon-lime related attributes of the beverage samples were lemon-lime aroma and lemon-lime flavor. Importantly, those attributes were not negatively affected by the inclusion of the taste modifiers phloretin and/or trilobtain.

While many examples in this document refer to taste modifiers and compositions and methods including such taste modifiers, it is understood that those compositions and methods are described in an exemplary manner only and that other compositions may be used. For example, any feature in one embodiment may be included in any other embodiment. Additionally, other ingredients may be used, depending on the particular needs. Although the foregoing specific details describe certain embodiments, persons of ordinary skill in the art will recognize that various changes may be made in the details of these embodiments without departing from the spirit and scope of this invention as defined in the appended claims and considering the doctrine of equivalents. Therefore, it should be understood that this invention is not limited to the specific details shown and described herein.

What is claimed is:

1. A beverage comprising:
one or more high-potency sweeteners;
phloretin at about 5 ppm to about 50 ppm; and
trilobtain at about 5 ppm to about 40 ppm;
wherein said trilobtain is present in an amount sufficient to decrease a cloying aftertaste of said beverage.

2. The beverage of claim 1 wherein a ratio of said phloretin to said trilobtain is between about 1:1 and about 3:1 by weight.

3. The beverage of claim 1 wherein the beverage provides less than about 40 calories for an 8 ounce serving; and
wherein a ratio of said phloretin to said trilobtain is between about 1.25:1 to about 1.75:1 by weight.

4. The beverage of claim 1 further comprising a lemon-lime flavor.

5. The beverage of claim 1 wherein said one or more high-potency sweeteners are selected from the group consisting of stevia leaf extract, sucralose, luo-han fruit extract, acesulfame-potassium, aspartame, and combinations thereof.

6. The beverage of claim 1 wherein said one or more high-potency sweeteners possess one or more aftertastes.

7. The beverage of claim 6 wherein said phloretin is present in an amount sufficient to suppress at least one of said one or more aftertastes.

8. A beverage comprising:
phloretin at about 5 ppm to about 150 ppm; and
trilobtain;
wherein a weight ratio of said phloretin to said trilobtain is between about 1:1 and about 3:1.

9. The beverage of claim 8 wherein the beverage is selected from the group consisting of partially sweetened beverages, sweetened beverages, and non-sweetened beverages.

10. The beverage of claim 8 further including a first sweetener or sweetener blend; and
wherein said beverage includes said phloretin and said trilobtain in amounts sufficient to decrease an aftertaste provided by a second sweetener or sweetener blend;
wherein said second sweetener or sweetener blend includes at least one sweetener selected from the group consisting of acesulfame-potassium, aspartame, stevia extract, luo-han fruit extract, and combinations thereof.

11. The beverage of claim 10 wherein the amounts of said phloretin and said trilobtain are sufficient to decrease said aftertaste provided by said second sweetener or sweetener blend for sucrose equivalent sweetness levels of between about 12 grams to about 38 grams of sucrose for an 8 ounce portion of said beverage.

12. The beverage of claim 8 further comprising a flavoring agent selected from the group consisting of lemon flavors, lime flavors, and combinations thereof.

13. The composition of claim 8 wherein the ratio of said phloretin to said trilobtain is between about 1.25:1 and about 1.75:1.

14. The beverage of claim 8 wherein said trilobtain is present in an amount sufficient to decrease a cloying aftertaste of said beverage.

15. The beverage of claim 8 further comprising:
one or more nutritive sweeteners; and
one or more high-potency sweeteners;
wherein said one or more high-potency sweeteners comprises stevia leaf extract in a concentration of about 50 ppm to about 100 ppm;
wherein said phloretin is between about 25 ppm to about 80 ppm;
wherein the beverage provides between about 60 calories and about 75 calories per 8 fluid ounces.

16. A method of adjusting the taste properties of a composition comprising:
adding phloretin to said composition;
wherein an amount of phloretin present in the composition following said addition of phloretin is sufficient to provide a cloying aftertaste; and
adding trilobtain to said composition;
wherein an amount of trilobtain present in the composition following said addition of trilobtain is sufficient to diminish said cloying aftertaste;
mixing the added trilobtain and added phloretin in the composition to form a beverage;
wherein the ratio of phloretin to trilobtain is between about 1:1 to about 3:1 by weight in said beverage.

17. The method of claim 16 further comprising addition of a sweetener to said beverage.

18. The method of claim 16 wherein said phloretin and said trilobtain are premixed in a taste modifying composition such that said adding phloretin and said adding trilobtain occur substantially simultaneously.

19. The method of claim 18 wherein said taste modifying composition is a sweetening composition.

20. The method of claim 16 wherein the composition possesses an aftertaste selected from the group of aftertastes consisting of bitter aftertaste, metallic aftertaste, dry aftertaste, astringent aftertaste, and combinations thereof.
